(19) United States
(12) Patent Application Publication
(10) Pub. No.: US 2004/0179482 A1
(43) Pub. Date: Sep. 16, 2004

(54) Auto-addressing mechanism for a networked system

(75) Inventor: Mircea Rusu, Toronto (CA)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: 777388 Ontario Limited

(21) Appl. No.: 10/712,585

(22) Filed: Nov. 13, 2003

Related U.S. Application Data
(63) Continuation of application No. PCT/CA03/00349, filed on Mar. 13, 2003.

(51) Int. Cl. H04L 12/28

(52) U.S. Cl. 370/254

(57) ABSTRACT

A system for assigning addresses to components in a networked system. The network includes a control unit and two or more functional components. The system provides the capability to address an individual component or a group of components in the network. The components may be speakers, sound masking units, lighting units, HVAC units or other elements coupled in a network. According to another aspect, there is a method for assigning addresses to components in a networked system having a plurality of components.

### FIELD OF THE INVENTION

The present invention relates to networked systems, and more particularly to an auto-addressing mechanism for a networked system.

### BACKGROUND OF THE INVENTION

Networks are widely used in a variety of environments including offices and universities. Networks typically include one or more control units and a plurality of components. A variety of components can be connected to networks. The control unit can be used to communicate with the components. In many applications, it is desirable to have components which are individually addressable so that the control unit can communicate with only selected components.

One method of communicating with selected components is to assign a unique identifier or address to each component in the network. When communication with a specific component or a selection of components is desired, the control unit can communicate with the desired component or components using the corresponding addresses. In many applications, components may be added and/or removed from the network, or the network may be reconfigured, for example, by creating new groupings of components. When such modifications to the network are desired, it may also be desirable to change the unique address assigned to the components. In most applications, changing the unique address assigned to selected network components requires rewiring of the device and/or other modifications to the physical aspects of the network. In many networks, this requires a technician to directly access the selected network components.

Accordingly, there exists a need for an auto-addressing mechanism for a networked system, and which mechanism allows network components to be easily assigned and/or re-assigned unique network addresses.

### BRIEF SUMMARY OF THE INVENTION

The present invention provides a system for assigning addresses to components in a networked system, said system comprises: (a) a communication network; (b) one or more functional components, at least some of the functional components including a communication interface for coupling the functional components to the communication network for receiving control signals over the communication network; and (c) a control unit having a communication interface for coupling the control unit to the communication network for transmitting control signals over the communication network to the functional components; and a component for assigning logical addresses for each of the functional components, the control signals including signals for selectively communicating with the functional components according to the logical addresses.

In another aspect, the present invention provides a method for assigning addresses to components in a networked system having one or more components, each component having an associated identifier, the method comprises the steps of: (a) selecting a component having a predetermined characteristic; (b) generating a logical address for the component, the logical address being derived from the identifier associated with the component; and (c) assigning the logical address to the component.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made to the accompanying drawings, which show, by way of example, embodiments of the present invention, and in which:

FIG. 1 shows in block diagram form a network having an auto-addressing mechanism according to one aspect of the present invention;

FIG. 2 shows in block diagram form a network having an auto-addressing mechanism according to another aspect of the present invention;

FIG. 3 shows in block diagram form a control unit for the network of FIG. 1 or 2;

FIG. 4 shows the control unit of FIG. 3 in more detail, and in particular the functional modules for the control unit;

FIG. 5 shows in flowchart form the steps for a system configuration function in the control unit for the network;

FIG. 6 shows in flowchart form the steps for configuring addresses for the components according to one aspect of the present invention;

FIG. 7 shows a component connected to the network according to one aspect of the present invention;

FIG. 8 shows in flowchart form the steps taken by a component in carrying out the steps for configuring addresses shown in FIG. 6; and

FIG. 9 shows in flowchart form a functional processing method for selecting control functions in the control unit for controlling the components and configuring the network.

### DETAILED DESCRIPTION OF THE PREFERRED EMBODIMENT

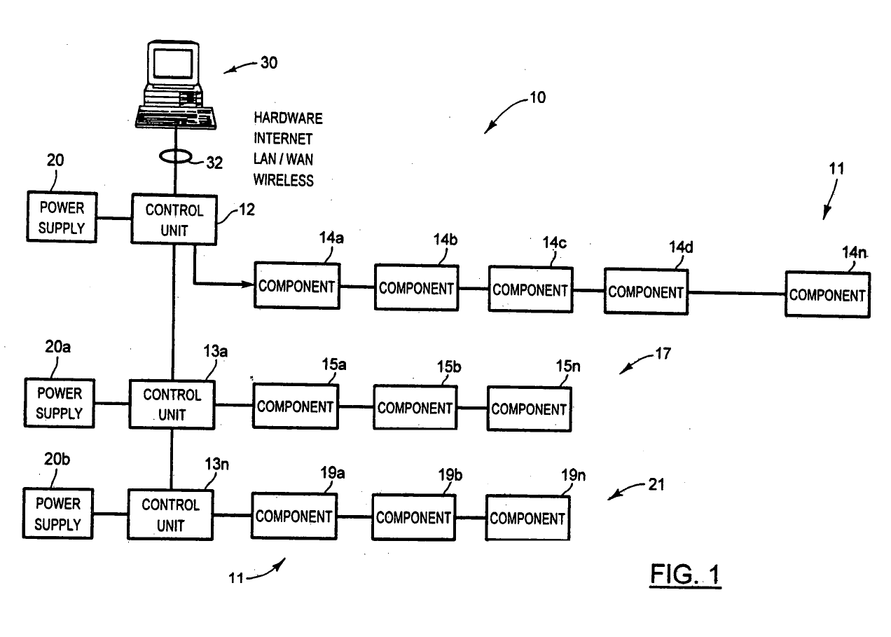

Reference is now made to FIG. 1, which shows in block diagram form a system comprising a network 11 having an auto-addressing mechanism according to the present invention. The system 10 is indicated generally by reference 10.

As shown in FIG. 1, the system 10 includes a control unit 12, and the network 11. The network 11 comprises a number of components 14, indicated individually by 14a, 14b, 14c, . . . , 14n. The physical connections for the network 11 between the components 14 may comprise 5 or 4 conductors. In a 5 conductor arrangement, two conductors carry power, two conductors provide communication channels, and one conductor provides for ground in an AC powered implementation. (In a DC implementation, the conductor for ground may be eliminated). The components 14 are speakers or sound masking units, but may be also be lighting units, heating units, ventilation units or fans, door locks, alarms, valves, sprinklers, motors or other components for which there is a need to monitor and/or modify component parameters. In this way, the auto-addressing mechanism may be used in a variety of network applications including heating and ventilation systems, speaker systems, public address systems, sound masking systems, lighting systems, door locking systems, security systems, audio systems, valve systems, intelligent sprinkler systems, regulator systems, test instruments, and motor controls.

As shown in FIG. 1, the control unit 12 includes a power supply unit 20, for example, a DC power supply, for providing a power feed to the components 14 coupled to the network 11. The control unit 12 may also include a communication/control link 32 to a computer 30, for example, a personal computer or PC. Through software the computer 30 provides an interface for configuring, administering, and running diagnostics relating to the system 10 and/or the network 11. The communication interface 32 also provides the capability to access the control unit 12 from a remote location, e.g. within the building or from an offsite location. The communication interface 32 may comprise a wireless link, a telephone communication channel, radio communication link, computer network (e.g. a Local Area Network (LAN) or a Wide Area Network (WAN)), or a connection through the Internet or World Wide Web (WWW). This provides flexibility in configuring, adjusting and maintaining the system 10 from a remote or off-site location using, for example, a wireless link or a Wide Area Network or Internet link.

According to another aspect of the invention, additional control units 13, indicated individually by 13a . . . 13n, may be coupled to the control unit 12, for example, in a daisy chain configuration. The control unit 13a is coupled to one or more components 15, indicated individually by 15a, . . . 15n, to form another network or zone 17. The control unit 13a and the network zone 17 allow a networked configuration for another physical space or zone in a building, e.g. another floor, while still being coupled to the first or primary control unit 12 in order to provide a centralized or primary control facility. Similarly, the nth control unit 13n is coupled to one or more components 19, indicated individually by 19a . . . 19n, to form another network or zone 21.

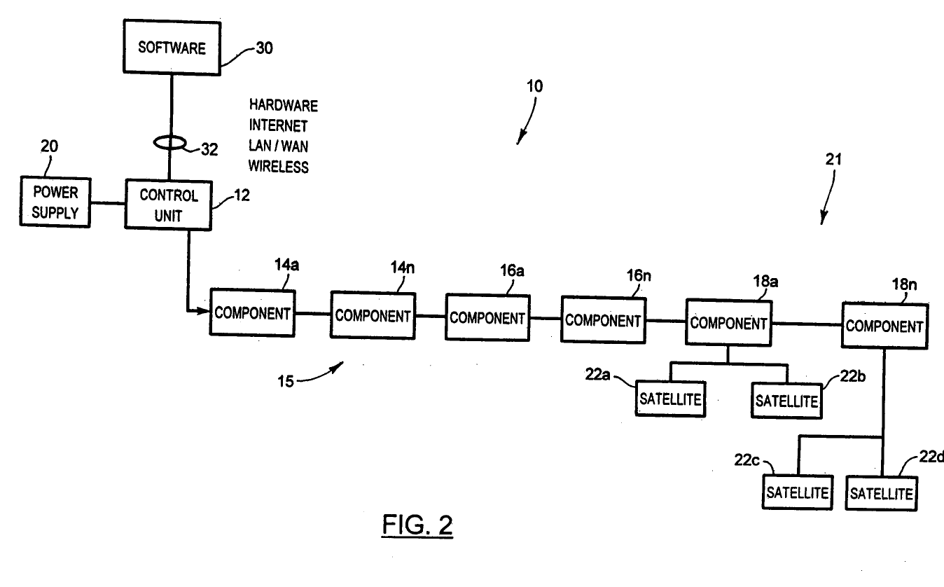

Reference is next made to FIG. 2, which shows in block diagram from a system 10 and network configuration according to another aspect of the invention. As shown, the system 10 includes a control unit 12, and a network 11. The network 11 includes components 14, indicated individually by 14a, . . . 14n, components 16, indicated individually by 16a, . . . 16n, and components 18, indicated individually by 18a. 18n. This arrangement provides a network 21 comprising different types of components 14, 16, and 18, each of which are individually addressable, and provides the capability to individually set the parameters for each of the components 14, 16, and 18 or a group of components 14, 16, and 18. In yet another aspect shown in FIG. 2, the components 18 include one or more satellite units or subcomponents 22. The subcomponents 22 are not directly coupled to the network 15 and therefore cannot be directly addressed by the control unit 12, rather the subcomponents 22 are controlled by the respective component to which they are coupled.

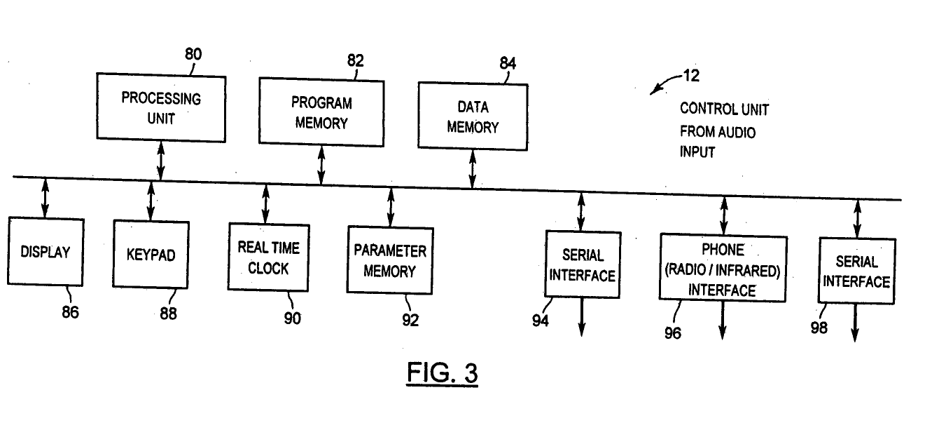

Reference is next made to FIG. 3, which shows the control unit 12 in more detail. The control unit 12 comprises a processing unit 80 (i.e. microprocessor or type of stored program control device), a program memory 82, a data memory 84, a display module 86, a keypad 88, a real-time clock module 90, a parameter memory 92, a first serial communication interface 94, a communication interface 96, and a second serial communication interface 98. The first serial communication interface 94 couples the control unit 12 to the components 14 in the network 11 (FIG. 1). The second serial communication interface 98 provides a communication interface for coupling the control unit 12 to the other control units 13 as described above with reference to FIG. 1. The communication interface 96 provides the communication link 32 to the computer 30 as described above with reference to FIG. 1.

The control unit 12 couples to the network 11 and provides the capability to adjust the functional aspects and/or operational characteristics of the components 14. The functions provided by the control unit 12 include, for example, configuration functions, diagnostic functions, and timer control functions. The control unit 12 configures the network 11 by assigning addresses to each of the components 14. The addressing of the individual components 14 enables the control unit 12 to direct commands and/or status requests to individual components 14, or to groups of components 14, or to the entire network 11 as a whole. The control unit 12 may be used to set/adjust the parameters for the selected (i.e. addressed) component 14, or perform diagnostic functions for the selected component 14.

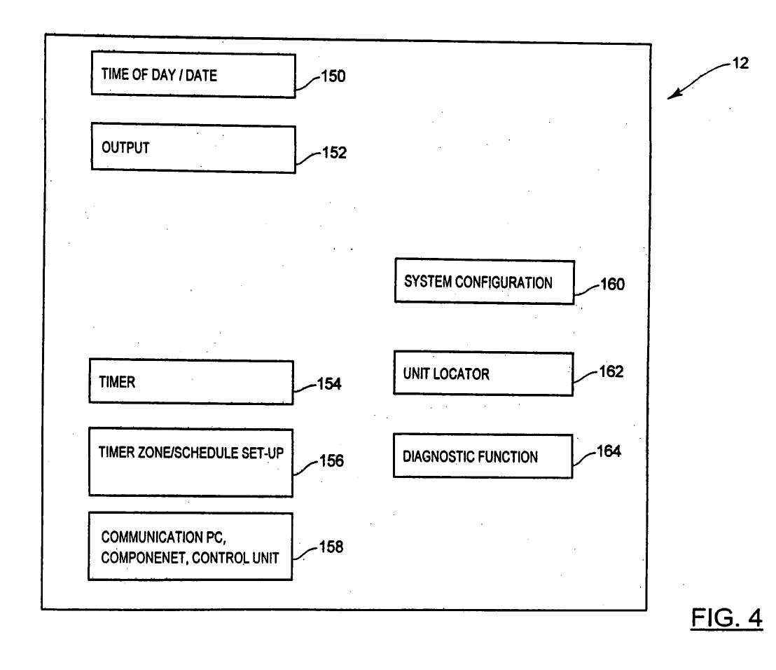

Reference is made to FIG. 4, which shows the functional modules embodied in the control unit 12 for performing various functions associated with the networked system 10. It will be appreciated that the number and types of functional modules depends on the particular application of the system 10, and the following are provided for illustrative purposes. The control unit 12 includes a functional module 150 for providing time of day and date functions, a functional module 152 to control the output of the components 14 according to preset parameters, a functional module 154 to provide timer functions for the system 10, a functional module 156 to provide timer zone/schedule set-up functions, a functional module 158 to control communication functions with the computer 30 (FIG. 1), the components 14 (FIG. 1), the control unit 12 and 13, a functional module 160 to provide system configuration functions (including self-addressing, i.e. the addressing of the components 14), a functional module 162 for locating particular components 14 in the network 11, and a functional module 164 for performing diagnostic functions. The control unit 12 may be capable of carrying out a variety of other functions and may contain other functional modules in addition to those described above.

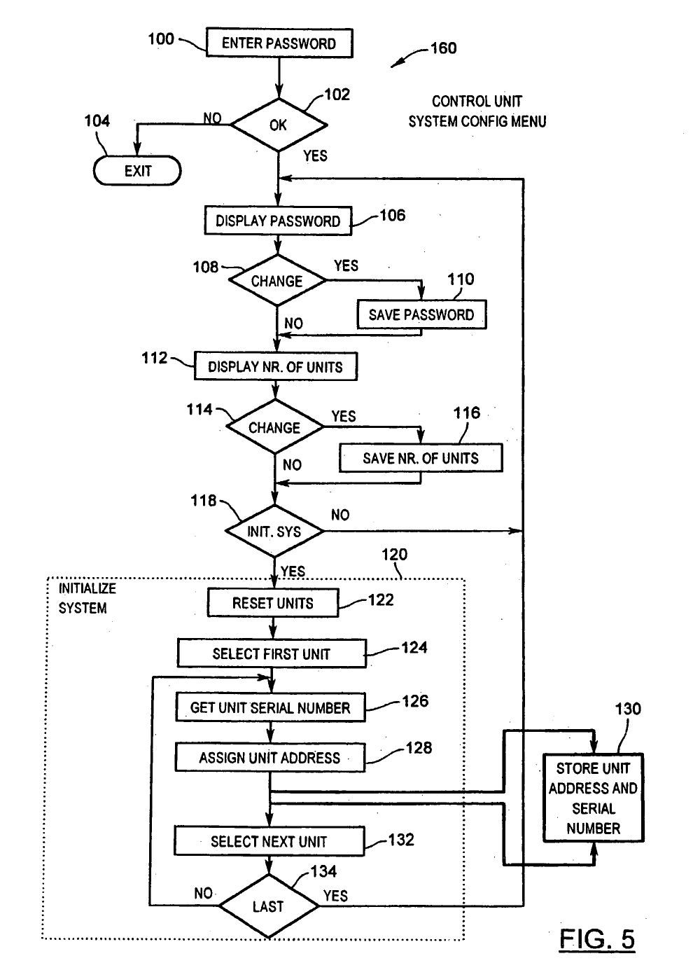

Reference is next made to FIG. 5, which shows the operation of the system configuration functional module 160 for the control unit 12 in more detail. The control unit 12 is password protected, and the first step 100 involves prompting the user to enter a password. If the password is incorrect (decision block 102), then further access is denied (block 104). If the entered password is correct, the password is displayed in block 106, and the user is given the option of changing the password (decision block 108). If the user changes the password, then the new password is saved in block 110. The next step 112 involves displaying the number of components 14 that are presently configured for the network 11. When the system 10 is being setup for the first time, the number of components 14 may be set at the factory or entered in the field by the technician. The user is given the option of changing the number of components 14 configured for the system 10 in decision block 114, and the new number of components 14 is stored in step 116. In decision block 118, the user is prompted to initialize the system 10. If the user elects to initialize the system 10, then the control unit 12 executes an initialization procedure (or re-initialization procedure) indicated generally by reference 120.

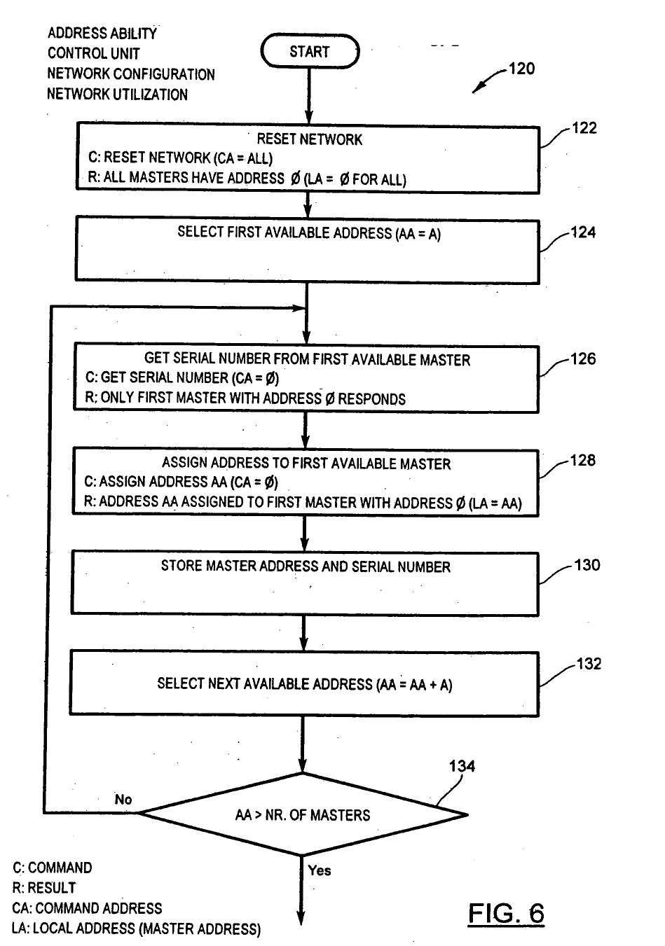

Reference is next made to FIG. 6, which shows the operation of the initialization procedure 120 performed by the system configuration functional module 160 (FIG. 4) for the network 11 in more detail. As shown, the first step 122 in the initialization procedure 120 involves resetting all of the components 14 (FIG. 1) connected to the network 11 (FIG. 1). The control unit 12 instructs all components in the network 11 to set their logical address to 0. As a result of the reset operation 122, each of the components 14 has a logical address of 0. In the next step 124, the control unit 12 selects the first available address (M), 1 for example. The control unit 12 then retrieves the serial number from the first available component 14 (block 126). Since all of the components 14 have a logical address of 0, only the first component 14 with logical address 0, i.e. the component 14a, responds when the control unit 12 queries the component 14 as indicated by block 126. The serial number forms an identifier which is assigned to the component 14 at the time of manufacture and comprises a code stored in non-volatile memory in the component 14. According to another aspect, the identifier is generated based on a positional reference which is derived from the physical location of the component 14.

The control unit 12 then assigns the first available logical address to the component 14 as indicated by block 128. As a result, the logical address of the first component 14 is set to the first available address. The logical address and serial number (or positional reference) are then stored (block 130), in memory, for example, in a look-up table in the control unit 12 which also provides a cross-reference to the component 14. The current logical address assigned to the component 14 in step 128 is unique for the present network configuration, but for another network configuration the logical addresses may be the same or different.

In the next step 132, the current logical address is incremented to obtain the next available address (i.e. M=M+1). The control unit 12 then compares the available address (AA) to the expected number of components 14 on the network 11 (as set by the user in block 114 in FIG. 5) as indicated by decision block 134. If the available address M is greater than the expected number of components 14, then the control unit 12 exits the initialization procedure (i.e. the auto-addressing process). If the available address M is less than or equal to the expected number of components 14, the control unit 12 repeats the operations for assigning the current logical address for the next component 14 according to steps 126 to 132 as described above. These operations are repeated until all of the components 14 have been assigned current logical addresses by the control unit 12 as indicated by decision block 134. Following this procedure, the current logical address for the last component 14 is equal to the number of components 14 connected to the networked system 10.

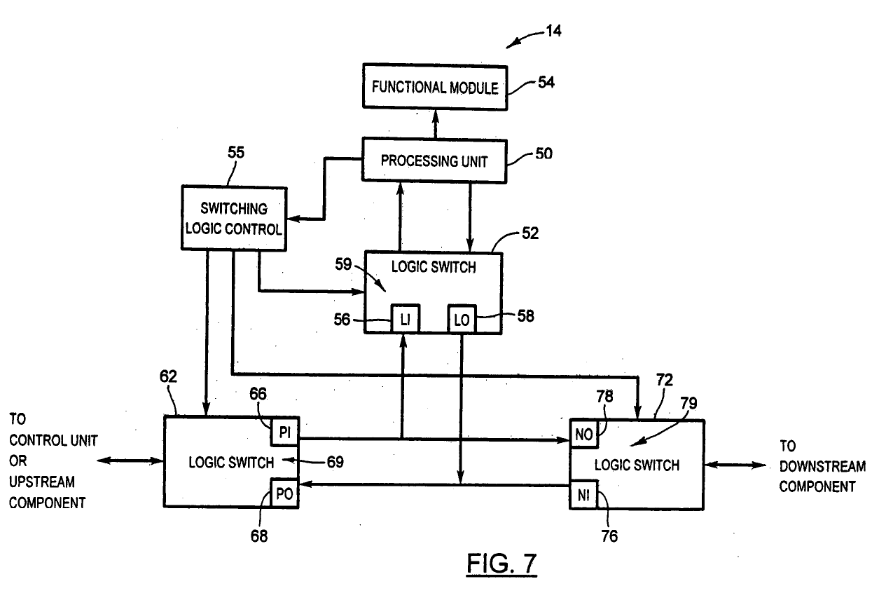

Reference is next made to FIG. 7, which shows in more detail a component 14, for example the component 14b, connected to the network 11 according to another aspect of the present invention. The component 14 comprises a processing unit 50 (i.e. a microprocessor), the logic switches 52, 62 and 72, a functional module 54, and a switching logic control module 55. The processing unit 50 controls the operation of the functional module 54 to provide the output of the component 14 according to the set parameters. The components 14 connected to the network 11 may have one or more functional modules. In one embodiment of the network 11, the components 14 comprise sound masking units which include a random noise generator module, an equalizer module for sound masking, an equalizer module for paging, a pulse width modulator or PWM stage, and a paging demultiplexer module.

The logic switch 52 together with the serial interface input 56 and the serial interface output 58 form a communication interface, indicated by reference 59, for the processing unit 50. The communication interface 59 couples the processing unit 50 in the component 14 to the network 11 (FIG. 1) and allows the component 14 to receive control commands and transmit responses. Data sent by the control unit 12 over the network 11, for example, paging signals/audio data, may also be received via the communication interface 59. The logic switch 52 connects the processing unit 50 to the serial interface input 56 and the serial interface output 58.

The components 14 are connected with other components 14 via the network 11. In the embodiment as shown, the component 14 is connected with an upstream (previous) component via its communication interface 69, and a downstream (next) component via its communication interface 79. The logic switch 62 together with the serial interface input 66 and the serial interface output 68 form the communication interface 69 for the upstream component. The logic switch 72 together with the serial interface input 76 and the serial interface output 78 form the communication interface 79 for the downstream component.

The serial interface input 56 allows the processing unit 50 to receive data from the control unit 12 (FIG. 1). The serial interface output 58 allows the processing unit 50 to send data to the control unit 12 (FIG. 1). In conjunction with the logic switch 52, the processing unit 50 monitors the serially encoded messages sent by the control unit 12 and acts upon messages which are addressed to the specified component 14.

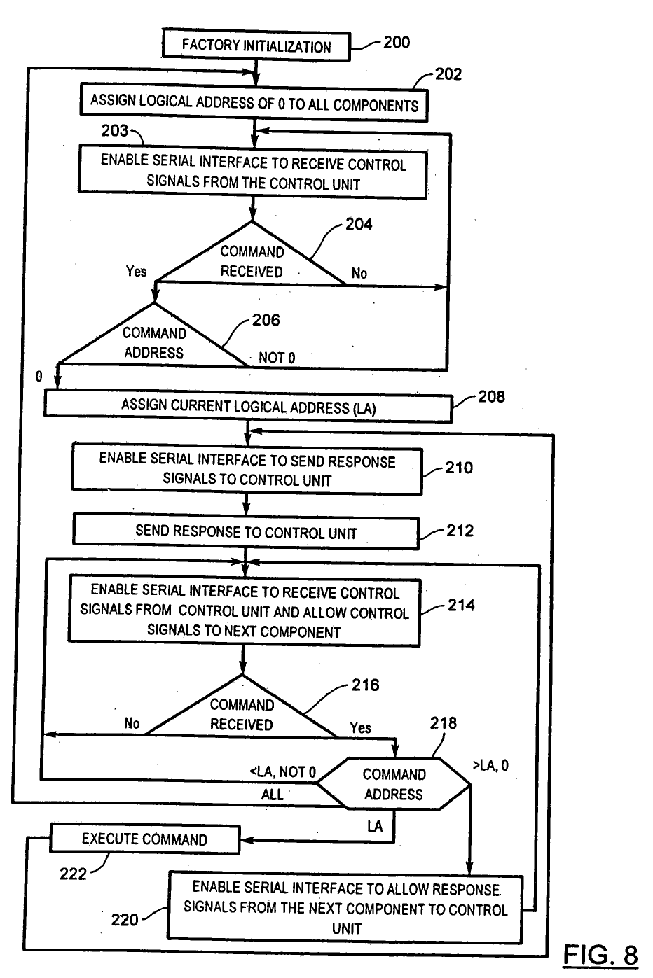

Reference is next made to FIG. 8, which shows the operation of the component 14 in response to the initialization procedure 120 of FIG. 6. The initialization procedure 120 is typically selected when the system 10 (FIG. 1) is first installed, when one or more additional components 14 (FIG. 1) are installed in the network 11 (FIG. 1), when one or more components 14 are removed from the network 11, or when the system 10 could otherwise benefit from the re-assignment of addresses to the components 14. Prior to the installation of the components 14 in the network 11, the components 14 are initialized by setting the logical address of each of the components 14 to 0 as indicated by block 201 in FIG. 8. This preliminary initialization step (block 201 in FIG. 8) of the components 14 may occur at the factory where the components 14 are produced or assembled.

The first step in the initialization procedure 120 is the resetting of the components 14 as indicated by block 122 (FIG. 6). The control unit 12 sends a command signal to all components 14 (FIG. 1) to set their logical address to 0 as indicated by block 202 in FIG. 8. In effect, all components 14 enable the communication pathways from the previous component (or from the control unit 12), and to the local processing unit 50 of the components 14. Communication pathways to the next component, from the next component, to the previous component, and from the local processing unit 50 are disabled. In this state, the components 14 wait for a command from the previous component or the control unit 12. This switching arrangement of the communication pathways provides for the control unit 12 to select only the first available component 14, i.e. component 14a, in accordance with step 124 (FIG. 6).

As indicated by decision block 204 in FIG. 8, if no command is received, the component 14 continues to wait. If a command is received, the component 14 checks to see if the command address equals 0 as indicated by decision block 206 in FIG. 8. If the command address is not equal to 0, then the component 14 continues to wait. If the command address does equal 0, then the component 14 assigns itself the logical address contained in the command. This logical address cannot be 0 (block 208).

Referring to FIG. 8, next in block 210 the component 14 enables the communication pathways to the previous component 14, from the previous component 14, to the local processing unit 50 (FIG. 7), and from the local processing unit 50 as indicated by block 214. The communication pathways to the next component 14, and from the next component 14 are disabled. In this state, the component 14 is preparing to respond to the command from the control unit 12. Any subsequent components 14 connected to the network 11 are not included in the communication and therefore do not receive any command signals and do not interfere. The component 14 then sends a response to the control unit 12 as indicated by block 212 in FIG. 8.

In block 214, the component 14 enables the communication pathways to the next component 14, and to the local processing unit 50 (FIG. 7). The communication pathways to the previous component 14, from the next component 14, and from the local processing unit 50 (FIG. 7) are disabled. In this state, the component 14 is waiting for a command from the control unit 12 and allows command signals received from the previous component 14 or the control unit 12 through to the next component 14.

As indicated by decision block 216 in FIG. 8, if no command is received, the component 14 continues to wait. If a command has been received, the component 14 checks the command address attached to the command signal as indicated by decision block 218. If the command address is less than the logical address of the component 14 and does not equal 0, then the component 14 waits for another command. If the command address is greater than the logical address of the component 14 or the command address equals 0, the component 14 enables the communication pathways from the previous component 14, to the previous component 14, from the next component 14, and to the local processing unit 50. The communication pathways to the next component 14 and from the local processing unit 50 are disabled. In this state, the next component 14 can respond to the control unit 12. The response from the next component 14 will be allowed through to the control unit 12. If the command address equals the logical address, then the component 14 will execute the command (block 222) and will respond to the control unit 12 (blocks 210, 212) and then will wait for another command (blocks 214, 216). If the command address equals “all”, then all the components 14 loop back to the beginning of the addressing process assigning themselves the logical address 0. The entire network 11 is thus reset and brought back to the initial state.

The status/response of the components 14 to the various command address and logical address combinations that are possible is shown in Table 1.

TABLE 1
Component Status

| Component Status | | PI | PO | NI | NO | LI | LO |
|---|---|---|---|---|---|---|---|
| No CA, LA = 0 | Idle, network | E | D | D | D | E | D |
| | reset | | | | | | |
| No CA, LA ≠ 0 | Idle, address | E | D | D | E | E | D |
| | assigned | | | | | | |
| CA = all | Command | E | D | D | E | E | D |
| | received | | | | | | |
| CA < LA, CA ≠ 0 | Command | E | D | D | E | E | D |
| | received | | | | | | |
| CA = LA | Command | E | E | D | D | E | E |
| | received | | | | | | |
| CA > LA | Command | E | E | E | D | E | D |
| | received | | | | | | |
| CA = 0, CA ≠ LA | Command | E | E | E | D | E | D |
| | received | | | | | | |

PI = Previous Component Input;
PO = Previous Component Output;
NI = Next Component Input;
NO = Next Component Output;
LI = Local Processor Input;
LO = Local Processor Output;
CA = Command Address
LA = Logical Address;
E = Enabled;
D = Disabled.

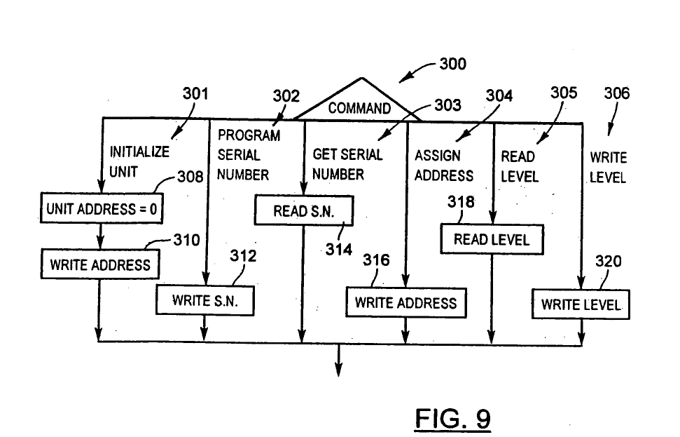

Reference is next made to FIG. 9, which shows in flowchart form a method for selecting control functions in the control unit 12 for controlling the components 14 and configuring the system 10. As shown, the control functions 300 include an initialization procedure 301, a program serial number procedure 302, a read serial number procedure 303, an assign logical address procedure 304, a read level procedure 305, and a write level procedure 306.

The initialization procedure 301 comprises a function 308 for resetting the logical addresses and a function 310 for writing logical addresses for the components 14 as described above with reference to FIG. 5 to 8. The program serial number procedure 302 provides a mechanism for programming or regenerating the serial number stored in non-volatile memory for each component 14. The procedure 302 comprises a write serial number function 312. The read serial number procedure 303 comprises a read serial number function 314 which the control unit 12 utilizes to read the serial numbers of the components 14, for example, as described above with reference to FIG. 5 to 8. The assign logical address procedure 304 comprises a write address function 316 for writing, i.e. assigning, logical addresses to the components 14. The read level procedure 305 comprises a read level function 318 which allows the control unit 12 to read the current levels for the various settings for the components 14 being addressed by the control unit 12. The write level procedure 306 comprises a write level function 320 which allows the control unit 12 to write the level for the selected function for the sound masking signal in the component 14 being addressed by the control unit 12. Once the component 14 is selected, the control unit 12 next selects the function to be queried/programmed, and then reads the parameter setting using the read level function 318, or writes the parameter setting, using the write level function 320.

Advantageously, the capability to address each of the components 14 allows the parameters to be individually set for each of the components 14 or a group of components 14, and this capability greatly enhances the functionality of the network 10 according to the present invention.

The auto-addressing mechanism may also be used in association with devices having the ability to communicate commands and information with an external device by the use of an “add-on” addressing and communication module according to the present invention. Any system having a large number of connected devices that are installed in a predictable pattern and could benefit from centralized control of these distributed devices may further benefit from the implementation of an auto-addressing mechanism therein.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A system for assigning addresses to components in a networked system, said system comprising:
(a) a communication network;
(b) a plurality of functional components, at least some of said functional components including a communication interface for coupling said functional components to said communication network for receiving control signals over said communication network; and
(c) a control unit, said control unit including, a communication interface for coupling said control unit to said communication network for transmitting control signals over said communication network to said functional components, and a component for assigning logical addresses for each of said functional components, said control signals including signals for selectively communicating with said functional components according to said logical addresses.

2. The system as claimed in claim 1, wherein said communication interface comprises an address component for recognizing control signals intended for one or more said functional components according to the logical addresses associated with said functional components.

3. The system as claimed in claim 2, wherein said control unit comprises a component for generating a logical address for each of said functional components, said logical address being derived from an identifier associated with each of said functional components.

4. The system as claimed in claim 3, wherein said identifier comprises a positional reference based on the physical location of said associated functional component.

5. The system as claimed in claim 3, wherein said identifier comprises a serial number associated with each of said functional components.

6. The system as claimed in claim 3, wherein said control signals further include signals for selectively controlling the operational characteristics of said functional components.

7. The system as claimed in claim 6, wherein at least some of said functional components include a control component, said control component being responsive to control signals for controlling the operational characteristics of said functional components.

8. The system as claimed in claim 6, wherein said functional components further include a switch for selectively directing said command signals from said control unit to said functional components.

9. The system as claimed in claim 8, wherein said switch directs said command signals to one or more said functional components according to the logical addresses associated with said functional components.

10. The system as claimed in claim 6, wherein at least some of said functional components are speakers.

11. The system as claimed in claim 6, wherein at least some of said functional components are sound masking units.

12. The system as claimed in claim 6, wherein at least some of said functional components comprise lighting units;

13. The system as claimed in claim 6, wherein at least some of said functional components comprise alarm units.

14. The system as claimed in claim 6, wherein at least some of said functional components comprise HVAC units.

15. A method for assigning addresses to components in a networked system having a plurality of components, each component having an associated identifier, said method comprising the steps of:
(a) selecting a component having a predetermined characteristic;
(b) generating a logical address for said component, said logical address being derived from the identifier associated with said component; and
(c) assigning said logical address to said component.

16. The method as claimed in claim 15, further comprising the step of storing said logical address in memory, wherein said logical address is stored in association with said identifier.

17. The method as claimed in one of claims 15 or 16, wherein the predetermined characteristic is a logical address of 0.

18. The method as claimed in claim 16, wherein said identifier comprises a positional reference based on the physical location of said associated functional component.

19. The method as claimed in claim 16, wherein said identifier comprises a serial number associated with each of said functional components.
